(19) United States
(12) Patent Application Publication
(10) Pub. No.: US 2009/0190741 A1
(43) Pub. Date: Jul. 30, 2009

(54) Method of Providing Routing Information to Contact Center

(75) Inventor: Neil O'Connor, Galway (IE)

Correspondence Address: BARNES & THORNBURG LLP, P.O. BOX 2786, CHICAGO, IL, 60690-2786, US

(73) Assignee: NORTEL NETOWRKS LIMITED, St. Laurent (CA)

(21) Appl. No.: 11/962,369

(22) Filed: Jan. 24, 2008

(51) Int. Cl. H04M 3/00

(52) U.S. Cl. 379/265.09

(57) ABSTRACT

A contact center receives an image and processes the image to identify useful information. From this information, a routing parameter is obtained for use in routing a contact relating to that image to an agent or other resource of the contact center. In this way a received image can be employed to route a contact.

### TECHNICAL FIELD

This invention relates to routing of contacts in a contact center.

### BACKGROUND ART

Contact centers provide for communications between external parties (referred to herein as “customers”) and resources of the contact center. These contact center resources are most usually human agents who speak with or message interactively with the customer, but can also be automated resources, such as interactive applications which are responsive to voice or keypad inputs or received messages, artificially intelligent agents, and recorded media playback applications.

Contact centers typically have limited resources, and these resources are typically quite specialised, so that for optimum operation of the contact center, a received contact must be analysed and directed to the most appropriate resource. Since the most appropriate resource may be busy, queuing mechanisms are common in contact centers, but there is nevertheless a need to place contacts in the most appropriate queue according to the information available to the contact center.

The term “intrinsic” is used within the art to mean a piece of information associated with a contact which may be used by a contact center to assist in determining a suitably skilled resource of the contact center to handle that contact. Typically, the intrinsics used by a conventional contact center to route a contact may include:
the number dialled by the customer to access the contact center
the media type being used for the contact (e.g. voice, video, instant messaging, SMS (short messaging service) text messages, email, etc.)
the customer's own number, IP address, IM or email address, etc.
stored history and account information relating to the customer
inputs provided by the customer during the contact session, such as responses to interactive voice prompts, menu choices navigated after connecting, etc.

Mediaseek Inc. of Tokyo, Japan, provide an image processing application which can reside on a mobile telephone platform (see www.camreader.jp/english/barcord_reader.html). Using the mobile telephone's onboard camera, images can be taken of encoded information, such as a barcode or of a piece of text, and the image processing application processes the image to decode the barcode or text. This decoded information can be used to create an entry in a contact list, to launch an email or a phone call to an encoded address or number, or to launch a web browser to an encoded URL, for example.

WO 2006/045729 discloses a mobile telephone equipped with a radio-frequency identification (RFID) chip reader. The RFID reader reads information stored in an RFID chip, and this information is sent to a contact center where it can be used as an intrinsic to help route the contact. The RFID chip may, for example, be located in a billboard advertisement or in a magazine, so that the transmission of information embedded in the RFID chip provides contextual information to the contact center. This system is very limited in its application, being restricted to contacts coming from customers who (a) have a handset equipped with an RFID reader, (b) have encountered an RFID chip which has been read by their handset, and (c) whose call to the contact center is in fact related to that RFID chip.

The present invention has as an object the provision of a new method of routing a contact within a contact center.

### DISCLOSURE OF THE INVENTION

The invention provides a method of routing a contact within a contact center, comprising the steps of:
(a) receiving an image at a contact center;
(b) deriving from the image a contact routing parameter;
(c) determining an appropriate resource of the contact center to handle a contact relating to the image based at least in part on the routing parameter; and
(d) routing the contact to the resource of the contact center.

This method provides a new kind of intrinsic information for routing contacts at a contact center. Rather than relying on information known about the customer or derivable from the communications session itself (originating number or address, called number or address, etc.), or derivable from a customer's interaction with an application (IVR voice or keypress inputs), a new category of information is proposed. Image information is employed to assist in routing a contact within the contact center.

The image can be a still image or a moving image. In contrast to a still image, a moving image may allow contact routing decisions to be made by analyzing how a system is changing over time, which brings an entirely new aspect to the routing decision.

Preferably, step (b) involves subjecting the image to an image analysis process in order to identify a characteristic feature of the image.

Further, preferably, the method involves the step of comparing the characteristic feature with a database to match and identify the feature.

In preferred scenarios, the characteristic feature of the image is selected from:
a location identifiable from the image;
a person identifiable from the image;
a product identifiable from the image;
a medical specialism requirement identifiable from the image;
a process occurring in a system which is identifiable from the image; and
an error condition identifiable from the image.

Thus, location information can be used to direct a contact to a contact center resource which is intended to offer assistance or information which is location-specific (such as providing directions, providing the nearest business of a given type, advising on transport options, restaurants, and so forth.

Identification of a person allows a contact to be prioritized based on the identity of the customer, in an alternative manner to systems which ask for an account number or password.

Identification of a product from an image is of particular use in contact centers offering technical support so that, for example, a user of a contact center can take an image of a problematic product and send this to a technical support contact center where it is analysed to identify the product and routed to an agent having knowledge of the product type. Similarly it can be used by customers who send an image of a desired product to a purchasing contact center, with the product being identified and the contact then forwarded to an agent who can assist the user with the purchase or that product type.

Identification of a medical specialism requirement allows an image, still or moving, to be sent to a medical assistance contact center where the analysis of the image allows the relevant medical speciality to be identified, so that the contact is routed to a specialist who can advise the customer on treatment, for example.

Identification of a process occurring in a system which is identifiable from the image has a wide range of uses, and allows a contact to be routed to a resource which is particularly suited to handle the contact according to the details of the process captured in the image.

Identification of an error condition identifiable from the image allows a contact to be routed to a support agent who can assist in resolving that error type, so that, for example, equipment errors which can be deduced from a pattern of LEDs can be routed to the most suitable available agent to handle the error shown.

Preferably, the image is received in step (a) as an attachment to a communication received from a user or customer of the contact center.

Non-limiting examples of such communications include emails, instant messages, multimedia messaging service (MMS) mobile telephone messages.

In the case of text-only messages, the image will not be attached but may be referenced such as by a URI, i.e. a pointer to the image is sent rather than the image itself, so that the contact center receives the image by downloading from the URI.

Alternatively, the image is received in step (a) as part of a communications session with a user or customer of the contact center, the communications session being of a type which includes image transmission.

Thus, for example, a customer may contact a contact center using a video call application, and still or moving images or captured from the video stream may be analysed and used to route the contact.

Optionally, the step of determining an appropriate resource of the contact center to handle a contact relating to the image is also based in part on information not derivable from the image.

Thus, the intrinsics used to route the contact will include both the image information and the non-image information (such as the caller's originating number, the caller's language, inputs to an IVR application, and so on). The crucial point is that the routing decision is at least partially based on image information also.

Preferably, when the contact is routed to the contact center resource, the image is made available to the resource.

Thus, for example, when a location is determined from the image and used to route the contact to an agent, the image itself may be sent to the agent so that the agent can verify the deduction made about the location. Similarly, where a medical contact is involved, the image of the affected body part, which may have been used to route the image, is sent to the agent so that the agent can visually assess the image. Mistakes in routing can be corrected by the agent (for example, an image of abnormal skin may have been routed to a dermatologist but the dermatologist may see that in fact the problem is a burn requiring the input of an emergency medicine specialist).

Optionally, when said contact routing parameter is derived from said image, confirmation of the routing parameter is requested from a customer or user of the contact center.

Thus, to again use the example of deducing a location from an image, the customer may be presented with the deduced location or with a list of candidate locations, so that confirmation from the customer aids in the routing of the contact. Such confirmation can be required in order to complete the routing decision, or it can be optional whereby the routing decision can be changed based on the further input from the customer.

The invention also provides a contact center comprising:
(a) a communications server with the ability to receive an image from a network;
(b) an image processing system configured to derive from the image a contact routing parameter;
(c) a plurality of resources for handling contacts; and
(d) a contact routing system configured to determine an appropriate resource from the plurality of resources to handle a contact relating to the image based at least in part on the routing parameter.

Preferably, the image processing system comprises a processor programmed to determine from the image a characteristic feature of the image, and a database against which the characteristic feature may be mapped.

In another aspect there is provided a computer program product comprising a data carrier encoding machine-readable instructions which, when executed in a computing system of a contact center, are adapted to cause the computing system to:
(a) on receiving an image, derive from the image a contact routing parameter;
(b) determine an appropriate resource of the contact center to handle a contact relating to the image based at least in part on the routing parameter; and
(c) route the contact to the resource of the contact center.

The invention further provides a computing system of a contact center having instructions stored thereon which when executed cause the computing system to:
(a) on receiving an image, derive from the image a contact routing parameter;
(b) determine an appropriate resource of the contact center to handle a contact relating to the image based at least in part on the routing parameter; and
(c) route the contact to the resource of the contact center.

### BRIEF DESCRIPTION OF THE DRAWINGS

The invention will now be further described by the following description of embodiments thereof, given by way of example only, with reference to the accompanying drawings, in which:

FIG. 1 is a block diagram of a system architecture; and

FIG. 2 is a flowchart illustrating a method of operation of the system of FIG. 1.

### DETAILED DESCRIPTION OF PREFERRED EMBODIMENTS

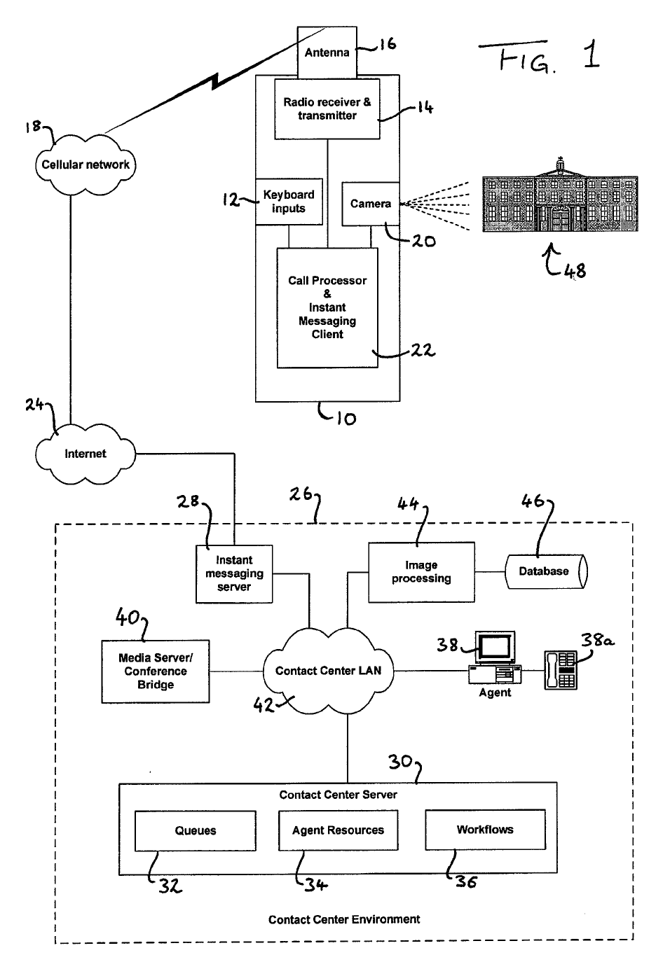

FIG. 1 shows a system comprising a mobile telephone 10 which employs a radio transmitter and receiver 14 and associated antenna 16 to connect the telephone 10 to a cellular network 18. Mobile telephone 10 is equipped with a keyboard 12 allowing user control over the functions of the telephone, and a camera 20. The telephone 10 is provided with appropriate conventional software to enable images taken by said camera to be sent to the cellular network 18 under the control of call processing and instant messaging software 22. As is well known in the art, such cellular telephones with messaging capabilities can generally also send images using multimedia messaging service or email messaging. The telephone 10 is thus wholly conventional and similar imaging and messaging functions could be provided by a camera-equipped and network-enabled personal digital assistant (PDA) for example.

Cellular network 18 is connected to other networks including the public switched telephone network (PSTN) (not shown) and the Internet 24. A contact center 26 is connected to the Internet 24 by an instant messaging server 28 of the contact center. Typically a contact center will have several media connections to the Internet and PSTN, allowing different types of contacts to be sent and received by the contact center, using a PBX or call server for voice and video calls, a SIP Server, an email server, a short messaging system (SMS) server, and so forth, all of which are omitted for simplicity from FIG. 1.

Contacts arriving at the contact center are controlled by a contact center server 30 which manages several functions, such as management of queues 32, management of agent resources 34, and workflow control of contacts 36. The contact center has several human agents located at workstations 38 with associated call/contact switching equipment 38a, which may be a traditional telephony switch or a softswitch or a SIP server, for example. Only one agent workstation 38 is shown but in a contact center there will typically be anything from tens to thousands of such workstations.

Agents 38 can connect to customers, such as a customer employing handset 10, under the control of contact center server 30. For example, an instant messaging contact received at instant messaging server 28 can be analyzed and allocated to an appropriate agent queue serviced by a pool of agents including agent 38; then when agent 38 becomes available to handle the contact, the agent's workstation is controlled to conference that agent into the instant messaging session held on the instant messaging server 28.

Similarly, voice calls received at the contact center are analyzed and queued to an appropriate agent. The physical call is terminated at a media server/conference bridge 40 while the contact is being queued, and when an appropriate agent such as agent 38 is allocated to the call, that agent's telephony equipment 38a is placed into a conference with the held call at conference bridge 40, allowing the agent and customer to speak. The communication between contact center entities is conducted in conventional manner over a contact center local area network (LAN) 42.

Instead of being placed in communication with a live human agent (or in addition to such communication) the customer could equally be routed to an automated resource of the contact center which would communicate information to and from the customer via instant messaging, voice telephony, or another media type. Other media types such as video calls, short messaging service (SMS) and multimedia messaging service (MMS) sessions, and email communications can of course also be handled by modern contact centers. As has been thus far described, the operation of the contact center 26 is entirely conventional and will be familiar to the skilled person.

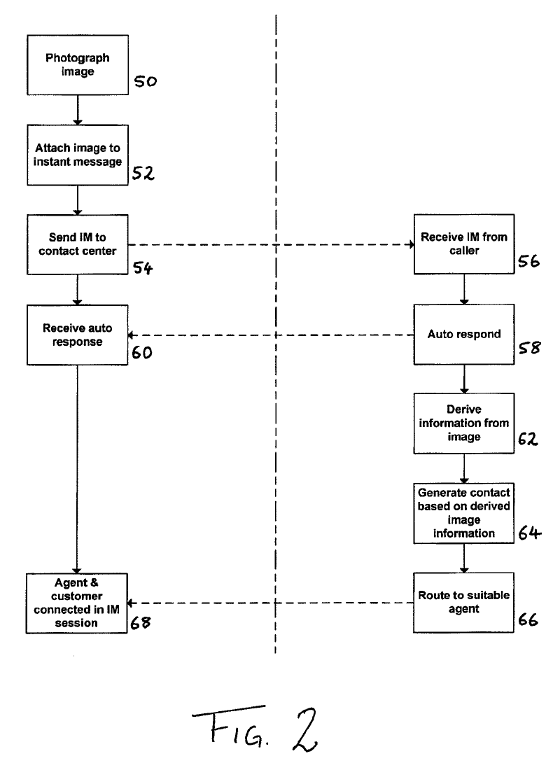

Unlike conventional contact centers, however, contact center 26 is also provided with a computing resource which operates image processing software 44 which has an associated database 46. The image processing software is operated, either alone or in conjunction with the database 46, to analyse images such as an image of a scene 48 taken by camera 20 of telephone 10 and communicated to the contact center 26 over the cellular network 18 and Internet 24. This process will now be described further with additional reference to FIG. 2.

In FIG. 2, a flowchart is provided illustrating the operation of the mobile telephone 10 (left hand side of FIG. 2) and the operation of the contact center 26 (the right hand side of FIG. 2).

The camera 20 of mobile telephone 10 is operated to photograph an image, step 50. The image may be, for example, a photograph of a building 48, to give just one example among numerous possibilities. The user of telephone 10 employs keyboard inputs 12 or some other interface such as a touch screen or voice input, to attach the image to an instant message (IM) for transmission by the call processor and IM client 22, step 52. The IM, with attached image, is sent to contact center 2, step 54.

Contact center 26 could, for example, be a contact center operated on behalf of a municipal public transport authority providing a service to assist users in their use of public transport within a city. Users are encouraged, by means of an advertising campaign or otherwise, to send a photograph of the nearest prominent building or landmark when they wish to be informed of public transport options servicing their location.

The IM with attached image is therefore received at IM server 28, step 56, and IM server 28 is programmed to automatically respond, step 58 to the user acknowledging receipt of the image. The user receives an automatic response as a reply IM, step 60.

The IM server forwards the received image to image processing software 44. Image processing software 44 can employ any suitable technique in order to identify a location from a received image. For example, operations such as edge extraction, noise removal, geometrical transformations such as rotating the image, and pattern recognition can be used to standardise and clean up the image and match it to an image stored in database 46, or in some other way to derive a location from the image (e.g. by recognising characters in street signs captured within the image). In any event, information is derived from the image, step 62, which is of use in further processing the contact. Optionally, when a match is made with a particular building in database 46, this can be notified to the mobile telephone 10, and optionally, the user can be requested to confirm the match. For example, the IM server 28 might send the user a library image of the user's supposed location, and the user could then confirm that the correct location had in fact been recognized. Such further confirmation is entirely optional, and can be supplemented by providing a number of choices to the user.

The result of the image processing is that information which has been derived from the image, software object corresponding to the IM contact received from the user is used to generate a contact. Further information which can be included in the contact object might include contact details of the mobile telephone, IM account details, time of contact, name, address or other contact information supplied by the user, and indeed any other conventional intrinsic information for routing a contact object. What is important is that the contact includes, in addition to any other intrinsics, the information derived from the image, step 64. Routing decisions are made based on the intrinsics, the routing decision being based at least in part on that location information, and the contact is routed to a suitable agent, step 66. The contact center server 30, on allocating the contact to a suitable agent, places the agent's workstation 38 into an IM session with the mobile telephone 10, allowing the agent and customer to interact further, such as by the agent providing directions, bus times or tourist information.

As a further example, a still or moving image taken of a patient could be sent to a contact center address such as MedicalAdvice@example.com, with the intention of obtaining advice which is relevant to the patient. Image processing software could analyse the received image at the contact center to automatically determine the medical specialization required to advise on the subject-matter of the image. If an image is identified as a flesh wound it is sent to an accident and emergency specialist to advise if stitches are required; rashes could be sent to a dermatologist; mouth and teeth images could be sent to a dental nurse; images of feet could be sent to a dermatologist; movies of an unsteady walking gait could be sent to a physiotherapist, and so on. In another medical example, by employing infrared image capture, the temperature of a suspected frostbite victim's extremities could be derived and used in routing a contact to a medical practitioner or mountain rescue team for diagnosis, evaluation or advice.

The image information can be not only analysed to derive information, but this information can then be combined with other available information, such as by deriving a location from an image of buildings, landmarks or landscape, and then combining this location with map-based information or vehicle availability information in order to better route the contact within the contact center.

The invention is not limited to the embodiments described above, and may be modified or varied without departing from the scope and spirit of the claimed invention.

What is claimed is:

1. A method of routing a contact within a contact center, comprising the steps of:
(a) receiving an image at a contact center;
(b) deriving from said image a contact routing parameter;
(c) determining an appropriate resource of the contact center to handle a contact relating to said image based at least in part on said routing parameter; and
(d) routing said contact to said resource of the contact center.

2. A method as claimed in claim 1, wherein said image is a still image.

3. A method as claimed in claim 1, wherein said image is a moving image.

4. A method as claimed in claim 1, wherein said step (b) of deriving a contact routing parameter from said image comprises subjecting said image to an image analysis process in order to identify a characteristic feature of said image.

5. A method as claimed in claim 4, further comprising the step of comparing said characteristic feature with a database to match and identify said feature.

6. A method as claimed in claim 4, wherein said characteristic feature of said image is selected from:
a location identifiable from said image;
a person identifiable from said image;
a product identifiable from said image;
a medical condition identifiable from said image;
a process occurring in a system which is identifiable from said image; and
an error condition identifiable from said image.

7. A method as claimed in claim 1, wherein said image is received in step (a) as an attachment to a communication received from a user or customer of said contact center.

8. A method as claimed in claim 1, wherein said image is received in step (a) as part of a communications session with a user or customer of said contact center, said communications session being of a type which includes image transmission.

9. A method as claimed in claim 1, wherein said step of determining an appropriate resource of the contact center to handle a contact relating to said image is also based in part on information not derivable from said image.

10. A method as claimed in claim 1, wherein when said contact is routed to said contact center resource, said image is made available to said resource.

11. A method as claimed in claim 1, wherein when said contact routing parameter is derived from said image, confirmation of the routing parameter is requested from a customer or user of the contact center.

12. A contact center comprising:
(a) a communications server with the ability to receive an image from a network;
(b) an image processing system configured to derive from said image a contact routing parameter;
(c) a plurality of resources for handling contacts; and
(d) a contact routing system configured to determine an appropriate resource from said plurality of resources to handle a contact relating to said image based at least in part on said routing parameter.

13. A contact center as claimed in claim 12, wherein said image processing system comprises a processor programmed to determine from said image a characteristic feature of the image, and a database against which said characteristic feature may be mapped.

14. A computer program product comprising a data carrier encoding machine-readable instructions which, when executed in a computing system of a contact center, are adapted to cause said computing system to:
(a) on receiving an image, derive from said image a contact routing parameter;
(b) determine an appropriate resource of the contact center to handle a contact relating to said image based at least in part on said routing parameter; and
(c) route said contact to said resource of the contact center.

15. A computing system of a contact center having instructions stored thereon which when executed cause said computing system to:
(a) on receiving an image, derive from said image a contact routing parameter;
(b) determine an appropriate resource of the contact center to handle a contact relating to said image based at least in part on said routing parameter; and
(c) route said contact to said resource of the contact center.
